(19) United States
(12) Patent Application Publication
(10) Pub. No.: US 2012/0161655 A1
(43) Pub. Date: Jun. 28, 2012

(54) BALLAST WITH ANTI-STRIATION CIRCUIT

(75) Inventors: Robert Martin, Nicholasville, KY (US); Carlos Becerra, Danvers, MA (US); Joseph Parisella, Beverly, MA (US); Paul Salvi, Versailles, KY (US)

(73) Assignee: OSRAM SYLVANIA Inc., Danvers, MA (US)

(21) Appl. No.: 13/332,621

(22) Filed: Dec. 21, 2011

Related U.S. Application Data
(60) Provisional application No. 61/426,282, filed on Dec. 22, 2010.

(51) Int. Cl. H05B 37/02

(52) U.S. Cl. 315/200 R; 315/209 R; 315/210; 315/224

(57) ABSTRACT

A ballast including an inverter circuit for providing an oscillating power signal for energizing at least one lamp. The inverter circuit includes a first transistor having a first gain and a second transistor having a second gain, each configured for alternately operating between a conductive state and a non-conductive state. The power signal has a waveform cycle comprising a first pulse generated when a first transistor operates in a conductive state, and a second pulse generated when the second transistor operates in a conductive state. The integral value of the first pulse of each waveform cycle of the power signal is different from the integral value of the second pulse of each waveform cycle such that a differential relationship between the first gain and the second gain is greater than or equal to a minimum value in order to minimize lamp striations.

### CROSS-REFERENCE TO RELATED APPLICATION

The present application claims priority of U.S. Provisional Application No. 61/426,282, filed Dec. 22, 2010, the entire contents of which are hereby incorporated by reference.

### TECHNICAL FIELD

The present invention relates to lighting, and more specifically, to electronic ballasts for operating one or more lamps.

### BACKGROUND

A typical ballast converts alternating current (AC) power from an AC power supply so that it is suitable for energizing one or more lamps connected to the ballast. A ballast may include a rectifier for generating a direct current (DC) signal from the AC power received from the AC power supply, a power factor correction circuit for correcting the DC signal generated by the rectifier, and an inverter for converting the corrected DC signal to an oscillating voltage for providing to the lamp.

A ballast is used to provide power for energizing various types of lamps, such as but not limited to gas discharge lamps. A gas discharge lamp, such as a fluorescent lamp, converts power received from the ballast into visible energy (i.e., light). While gas discharge lamps are commonly used in various lighting applications, they often produce a visual effect known in the art as “striations.” Striations refer to alternating bands of bright and dim areas that form along an axis of a tube of a gas discharge lamp. They may take the appearance of a standing wave.

### SUMMARY

Embodiments of the present invention provide a ballast designed to minimize striations from being produced by a lamp when the lamp is powered by the ballast. The ballast is configured for connecting to an alternating current (AC) power supply, and includes a rectifier for receiving an AC voltage signal via the power supply and producing a rectified voltage signal therefrom. A power factor correction circuit receives the rectified voltage signal and provides a corrected voltage signal. An inverter circuit receives the corrected voltage signal and generates an oscillating power signal for energizing the lamp as a function of the corrected voltage signal. The power signal has a waveform cycle comprising a first pulse that has a first integral value, and a second pulse that has a second integral value.

In an embodiment, there is provided a ballast to energize at least one lamp. The ballast includes: an inverter circuit to provide an oscillating power signal to energize the at least one lamp, wherein the oscillating power signal has a waveform cycle comprising a first pulse that has a first integral value and a second pulse that has a second integral value, wherein the inverter circuit includes: a first transistor having a first gain (h_{FE1}), wherein the first transistor is configured to alternately operate between a conductive state and a non-conductive state; and a second transistor having a second gain (h_{FE2}), wherein the second transistor is configured to alternately operate between a conductive state and a non-conductive state; wherein when the first transistor operates in the conductive state, the second transistor operates in the non-conductive state and the first pulse of a waveform cycle of the oscillating power signal is generated and the first integral value of the first pulse is a function of first gain (h_{FE1}); wherein when the second transistor operates in the conductive state, the first transistor operates in the non-conductive state and the second pulse of a waveform cycle of the oscillating power signal is generated and the second integral value of the second pulse is a function of the second gain (h_{FE2}); and wherein the first integral value of the first pulse of each waveform cycle of the oscillating power signal is different from the second integral value of the second pulse of each waveform cycle such that a differential relationship between first gain (h_{FE1}) and the second gain (h_{FE2}) is greater than or equal to a minimum value in order to minimize striations in the at least one lamp.

In a related embodiment, the differential relationship may include

$$\vert \frac{{h}_{FE 1} - 10}{12} - \frac{{h}_{FE 2} - 10}{12} \vert \geq 1.$$

In another related embodiment, the minimum value may be dependent on an expected ambient temperature for the ballast. In a further related embodiment, the minimum value may be equal to 1 when the expected ambient temperature for the ballast is around 21 degrees Celsius. In another further related embodiment, the minimum value may be equal to 2 when the expected ambient temperature for the ballast is around 8 degrees Celsius.

In yet another related embodiment, the ballast may further include: a rectifier to receive an alternating current (AC) voltage signal and to produce a rectified voltage signal therefrom; and a power factor correction circuit to receive the rectified voltage signal and to provide a corrected voltage signal, wherein the inverter circuit may be connected to the power factor correction circuit and the inverter circuit may be configured to generate the oscillating power signal as a function of the corrected voltage signal. In still another related embodiment, the ballast may be configured to energize a plurality of lamps.

In another embodiment, there is provided a ballast to energize at least one lamp. The ballast includes: an inverter circuit to provide an oscillating power signal to energize the at least one lamp, wherein the oscillating power signal has a waveform cycle comprising a first pulse that has a first integral value and a second pulse that has a second integral value, and wherein the inverter circuit includes: a first transistor having a first gain (h_{FE1}) and configured to alternately operate between a conductive state and a non-conductive state, wherein the first transistor has a base terminal, a collector terminal, and an emitter terminal; a first drive circuit connected to the base terminal of the first transistor to drive the first transistor, the first drive circuit comprising a resistive component having a resistance value (R34); a second transistor having a second gain (h_{FE2}) and configured to alternately operate between a conductive state and a non-conductive state, wherein the second transistor has a base terminal, a collector terminal, and an emitter terminal; a second drive circuit connected to the base terminal of the second transistor to drive the second transistor; wherein when the first transistor operates in the conductive state, the second transistor operates in the non-conductive state and the first pulse of a waveform cycle of the oscillating power signal is generated and the first integral value of the first pulse is a function of first gain (h_{FE1}); wherein when the second transistor operates in the conductive state, the first transistor operates in the non-conductive state and the second pulse of a waveform cycle of the oscillating power signal is generated and the second integral value of the second pulse is a function of the second gain (h_{FE2}); and wherein the first integral value of the first pulse of each waveform cycle of the power signal is different from the second integral value of the second pulse of each waveform cycle such that is

$$\vert \frac{{h}_{FE 2} - 10}{12} - \frac{{h}_{FE 1} - 10}{12} - R 34 \vert$$

greater than or equal to a minimum value in order to minimize striations in the at least one lamp.

In a related embodiment, the minimum value may be equal to 1. In another related embodiment, the resistive component may be a resistor connected to the base terminal of the first transistor. In yet another related embodiment, the first drive circuit may further include a diode and a resistor, wherein the diode and the resistive component may be connected together in a series combination, and the series combination of the diode and the resistive component may be connected in parallel with the resistor. In still another related embodiment, the second drive circuit may include a diode and a resistor connected together in parallel. In yet still another related embodiment, the ballast may further include: a rectifier to receive an alternating current (AC) voltage signal and to produce a rectified voltage signal therefrom; and a power factor correction circuit to receive the rectified voltage signal and to provide a corrected voltage signal, wherein the inverter circuit may be connected to the power factor correction circuit and the inverter circuit may be configured to generate the oscillating power signal as a function of the corrected voltage signal.

In still yet another related embodiment, the minimum value may be dependent on an expected ambient temperature for the ballast.

In another embodiment, there is provided a ballast to energize at least one lamp. The ballast includes: an inverter circuit to provide an oscillating power signal to energize the at least one lamp, wherein the oscillating power signal has a waveform cycle comprising a first pulse that has a first integral value and a second pulse that has a second integral value, wherein the inverter circuit includes: a first transistor having a first gain (h_{FE1}) and configured to alternately operate between a conductive state and a non-conductive state, wherein the first transistor has a base terminal, a collector terminal, and an emitter terminal; a first drive circuit connected to the base terminal of the first transistor to drive the first transistor; a second transistor having a second gain (h_{FE2}) and configured to alternately operate between a conductive state and a non-conductive state, wherein the second transistor has a base terminal, a collector terminal, and an emitter terminal; a second drive circuit connected to the base terminal of the second transistor to drive the second transistor, the second drive circuit comprising a resistive component having a resistance value (R34); wherein when the first transistor operates in the conductive state, the second transistor operates in the non-conductive state and the first pulse of a waveform cycle of the oscillating power signal is generated and the first integral value of the first pulse is a function of first gain (h_{FE1}); wherein when the second transistor operates in the conductive state, the first transistor operates in the non-conductive state and the second pulse of a waveform cycle of the oscillating power signal is generated and the second integral value of the second pulse is a function of the second gain (h_{FE2}); and wherein the first integral value of the first pulse of each waveform cycle of the oscillating power signal is different from the second integral value of the second pulse of each waveform cycle such that

$$\vert \frac{{h}_{FE 1} - 10}{12} - \frac{{h}_{FE 2} - 10}{12} - R 34 \vert$$

is greater than or equal to a minimum value in order to minimize striations in the at least one lamp.

In a related embodiment, the minimum value may be equal to 1. In another related embodiment, the second drive circuit may further include a diode and a resistor, wherein the diode and the resistive component may be connected together in a series combination, and the series combination of the diode and the resistive component may be connected in parallel with the resistor. In still another related embodiment, the first drive circuit may include a diode and a resistor connected together in parallel. In yet another related embodiment, the ballast may further include: a rectifier to receive an alternating current (AC) voltage signal and to produce a rectified voltage signal therefrom; and a power factor correction circuit to receive the rectified voltage signal and to provide a corrected voltage signal, wherein the inverter circuit may be connected to the power factor correction circuit and the inverter circuit may be configured to generate the oscillating power signal as a function of the corrected voltage signal. In still yet another related embodiment, the minimum value may be dependent on an expected ambient temperature for the ballast.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 is a schematic diagram, partially in block form, of a ballast/lamp system according to embodiments disclosed herein.

FIG. 2 is a model of a waveform of an exemplary oscillating power signal generated by the ballast/lamp systems illustrated in FIG. 1.

FIGS. 3 and 4 are each a schematic diagram, partially in block form, of a ballast/lamp system according to embodiments disclosed herein.

### DETAILED DESCRIPTION

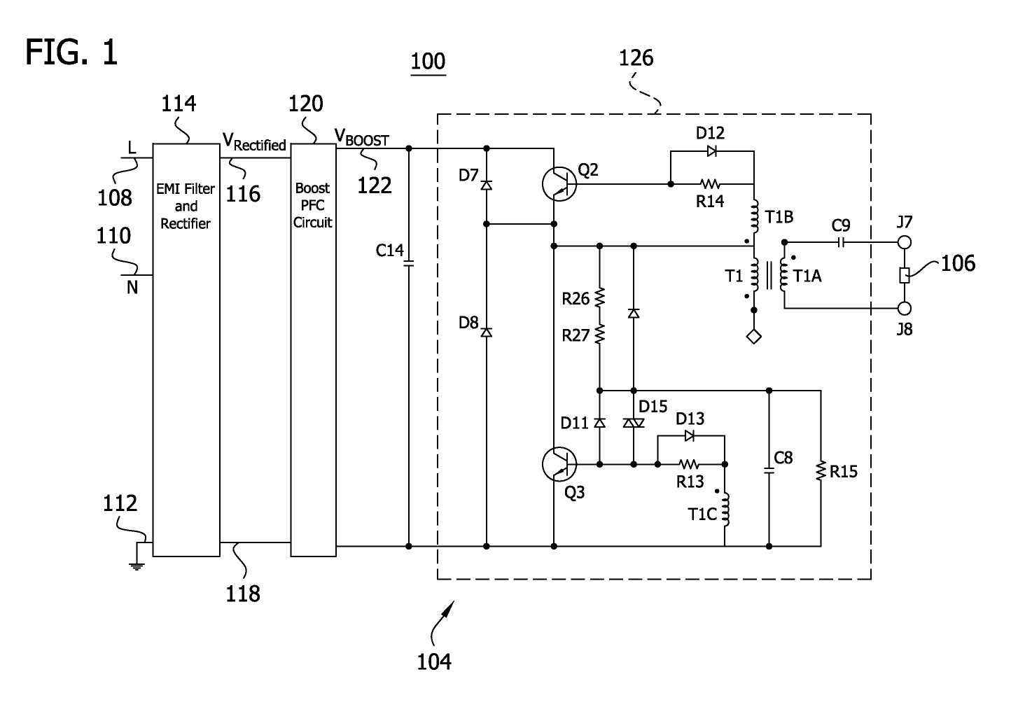

FIG. 1 illustrates a ballast/lamp system 100, which may also be referred to herein as a lamp system 100. The ballast/lamp system 100 includes an input power source (not shown), such as but not limited to an alternating current (AC) power supply, an electronic ballast 104 (hereinafter a ballast 104), and a lamp 106. In some embodiments, the lamp 106 is a T8 fluorescent lamp available from OSRAM SYLVANIA, Philips, or General Electric. However, the scope of the application contemplates the use of other types of lamps as well. Additionally, as described below, the ballast/lamp system 100 may include a plurality of lamps 106 connected together in parallel or in series.

The ballast 104 includes at least one high voltage input terminal (i.e., line voltage input terminal) 108 adapted for connecting to the alternating current (AC) power supply (e.g., standard 120V AC household power), a neutral input terminal 110, and a ground terminal 112 connectable to ground potential. An input AC power signal is received by the ballast 104 from the AC power supply via the high voltage input terminal 108. The ballast 104 includes an electromagnetic interference (EMI) filter and a rectifier (e.g., full-wave rectifier) 114, which are illustrated together in FIG. 1. The EMI filter portion of the EMI filter and rectifier 114 prevents noise that may be generated by the ballast 104 from being transmitted back to the AC power supply. The rectifier portion of the EMI filter and rectifier 114 converts AC voltage received from the AC power supply to direct current (DC) voltage. The rectifier portion includes a first output terminal connected to a DC bus 116 and a second output terminal connected to a ground potential at a ground connection point 118. Thus, the EMI filter and rectifier 114 outputs a DC voltage (V_{Rectified}) on the DC bus 116.

A power factor correction circuit 120, which may, in some embodiments, be a boost converter, is connected to the first and second output terminals of the EMI filter and rectifier 114. The power factor correction circuit 120 receives the rectified DC voltage (V_{Rectified}) and produces a high DC voltage (V_{Boost}) on a high DC voltage bus (“high DC bus”) 122. A shunt capacitor C14 is connected across the output of the power factor correction circuit 120. An inverter circuit 126 has an input connected to the power factor correction circuit 120 for receiving the high DC voltage (V_{Boost}) from the power factor correction circuit 120. The inverter circuit 126 is configured to convert the high DC voltage (V_{Boost}) from the power factor correction circuit 120 to an oscillating power signal for supplying to the lamp 106.

In FIG. 1, the inverter circuit 126 includes a first switching component Q2 and a second switching component Q3. For example, the first and second switching components, Q2 and Q3, may each comprise a bipolar junction transistor (BJT) such as but not limited to an NPN BJT. As such, the first switching component Q2 and the second switching component Q3 each have a collector terminal, a base terminal, and an emitter terminal. The first and second switching components, Q2 and Q3, complementarily operate between a non-conductive state and a conductive state in order to produce the oscillating power signal. A first drive circuit is formed by a transformer winding T1B, a diode D12, and a resistor R14. The first drive circuit drives the first switching component Q2. Similarly, a second drive circuit is formed by a transformer winding TIC, a diode D13, and a resistor R13. The second drive circuit drives the second switching component Q3. A diode D7 is connected across the emitter and collector terminals of the first switching component Q2, and a diode D8 is connected across the emitter and collector terminals of the second switching component Q3. The diodes D7 and D8 eliminate current spikes from the first and second switching components, Q2 and Q3, respectively.

A starting circuit is connected between the base and emitter terminals of the second switching component Q3. The starting circuit includes a diode for alternating current (DIAC) D15, a resistor R15, and a capacitor C8. The DIAC D15 has a predetermined breakover voltage. When a voltage at an input to the DIAC D15 (i.e., a voltage across the capacitor C8) increases to the predetermined breakover voltage, the DIAC D15 switches from operating in a non-conductive mode to operating in a conductive mode. As such, the DIAC D15 conducts a startup pulse to the second switching component Q3 to initiate switching operations. In FIG. 1, once the voltage across the resistor R15 reaches the predetermined breakover voltage (e.g., 32 Volts), the DIAC D15 breaks down and the inverter circuit 126 is started.

Once the second switching component Q3 is initially turned on via the starting circuit, the inverter circuit 126 operates in a normal operating mode wherein the first and second switching components, Q2 and Q3, are complementarily commutated via the first and second drive circuits. In other words, the first and second switching components, Q2 and Q3, are operated such that when the first switching component Q2 is conductive (e.g., ON), the second switching component Q3 is non-conductive (e.g., OFF). Likewise, when the second switching component Q3 is conductive (e.g., ON), the first switching component Q2 is non-conductive (e.g., OFF). The inverter circuit 126 includes a conduction control circuit for preventing the DIAC D15 from conducting during the normal operating mode. The conduction control circuit includes a diode D11, a diode D6, a resistor R26, and a resistor R27. The diode D11 is connected in parallel with the DIAC D15. The resistor R27 and the resistor R26 are connected together in series between the cathode of the diode D11 and the collector terminal of the second switching component Q3. The diode D6 is connected in parallel with the series connected resistors, R26 and R27, such that the anode of the diode D6 is connected to the cathode of the diode D11, and the cathode of the diode D6 is connected to the collector terminal of the second switching component Q3.

The inverter circuit 126 includes a transformer providing the oscillating power to the lamp 106. In particular, a primary winding T1 of the transformer is connected to the collector terminal of the second switching component Q3. A secondary winding T1A of the transformer is configured for connecting in series with the lamp 106. A current limiting capacitor C9 is also connected in series with the lamp 106, between the secondary winding T1A of the transformer and the lamp 106, in order to limit the current received by the lamp 106. In embodiments wherein the ballast/lamp system 100 powers a plurality of lamps, each lamp is connecting in series with a corresponding current limiting capacitor, between the secondary winding T1A of the transformer and the return terminal J8. As such, each of the pairs of a series-connected lamp and a corresponding current limiting capacitor are connected together in parallel. In FIG. 1, the primary winding T1, the secondary winding T1A, and the base drive windings T1B, T1C are wound on one core. However, it should be noted that the present application contemplates that the some or all of the windings (i.e., the primary winding T1, the secondary winding T1A, and the base drive windings T1B, T1C) may be wound on separate cores.

As described above, in FIG. 1, the first switching component Q2 is a first transistor (hereinafter “first transistor Q2”), and the second switching component Q3 is a second transistor (hereinafter “second transistor Q3”). In some embodiments, the first and second transistors, Q2 and Q3, are each an NPN BJT. For example, the first transistor and the second transistor may each be a BUL741 or BUL742/ST transistor available from ST Microelectronics. As is generally known in the art, other similar transistors may alternatively be used. The first transistor Q2 has a first gain h_{FE1}, and the second transistor Q3 has a second gain h_{FE2}. In some embodiment, the first gain h_{FE1} represents the ratio of collector current divided by base current at an operating point for the first transistor Q2. Similarly, the second gain h_{FE2} represents the ratio of collector current divided by base current at an operating point for the second transistor Q3. As further described below, the first and second transistors, Q2 and Q3, are selected so that the first and second gains, h_{FE1} and h_{FE2}, are different in order to minimize lamp striations.

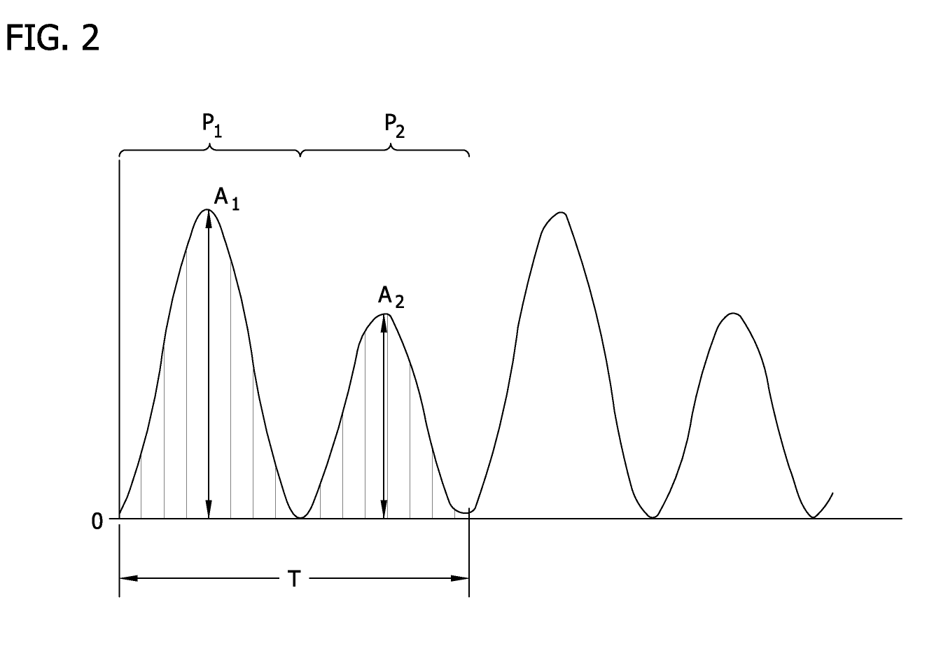

FIG. 2 illustrates an exemplary model of a waveform of an oscillating power signal that is provided by the ballast 104 via the inverter circuit 126 to the lamp 106. As illustrated in FIG. 2, the oscillating power signal has waveform cycle comprising a first pulse, indicated by P₁, and a second pulse, indicated by P₂. The period for the cycle, indicated by T, represents the duration (i.e., length of time) of one cycle. As described above, the first and second transistors, Q2 and Q3, are complementarily commutated. In particular, when the first transistor Q2 operates in the conductive state, the first pulse P₁ is generated. Similarly, when the second transistor Q3 operates in the conductive state, the second pulse P₂ is generated. The first pulse P₁ has a first integral value (i.e., area defined by the first pulse P₁), a first amplitude A₁, and a first duration T₁. The first integral value is a function of the first amplitude A₁ and the first duration T₁ (i.e., length of time of first pulse P₁). The second pulse P₂ has a second integral value (i.e., area defined by the second pulse P₂), a second amplitude A₂, and a second duration T₂ (i.e., length of time of second pulse P₂). The second integral value is a function of the second amplitude A₂ and the second duration T₂. Striations occurring in the lamp 106 are effected by the relationship between the first integral value and the second integral value. In some embodiments, the first integral value and the second integral value must be different values in order to minimize lamp striations.

Referring again to FIG. 1, in the ballast/lamp system 100, the first amplitude A₁ is a function of the first gain h_{FE1} of the first transistor Q2, and the second amplitude A₂ is a function of the second gain h_{FE2} of the second transistor Q3. In accordance therewith, striations in the lamp 106 are minimized when a differential relationship between the first gain h_{FE1} and the second gain h_{FE2} is greater than or equal to a specific minimum value (i.e., predefined number greater than zero). In some embodiments, as the minimum value is increased, lamp striations are decreased. According to the ballast/lamp system 100 shown in FIG. 1, the lamp striations are minimized when the following condition is satisfied:

$$\vert \frac{{h}_{FE 1} - 10}{12} - \frac{{h}_{FE 2} - 10}{12} \vert \geq 1 \qquad ( equation 1 )$$

As such, the first transistor Q2 and the second transistor Q3 are selected and/or designed so that the first gain h_{FE1} and the second gain h_{FE2} have particular values governed by equation 1.

In some embodiments, the minimum value is dependent on an expected ambient temperature where the ballast will be used. In particular, as the expected ambient temperature decreases, the minimum value increases. For example, a minimum value of 1 as expressed above in equation 1 may be used when the expected ambient temperature is around 21 degrees Celsius. On the other hand, a minimum value of 2 may be used when the expected ambient temperature is around 8 degrees Celsius.

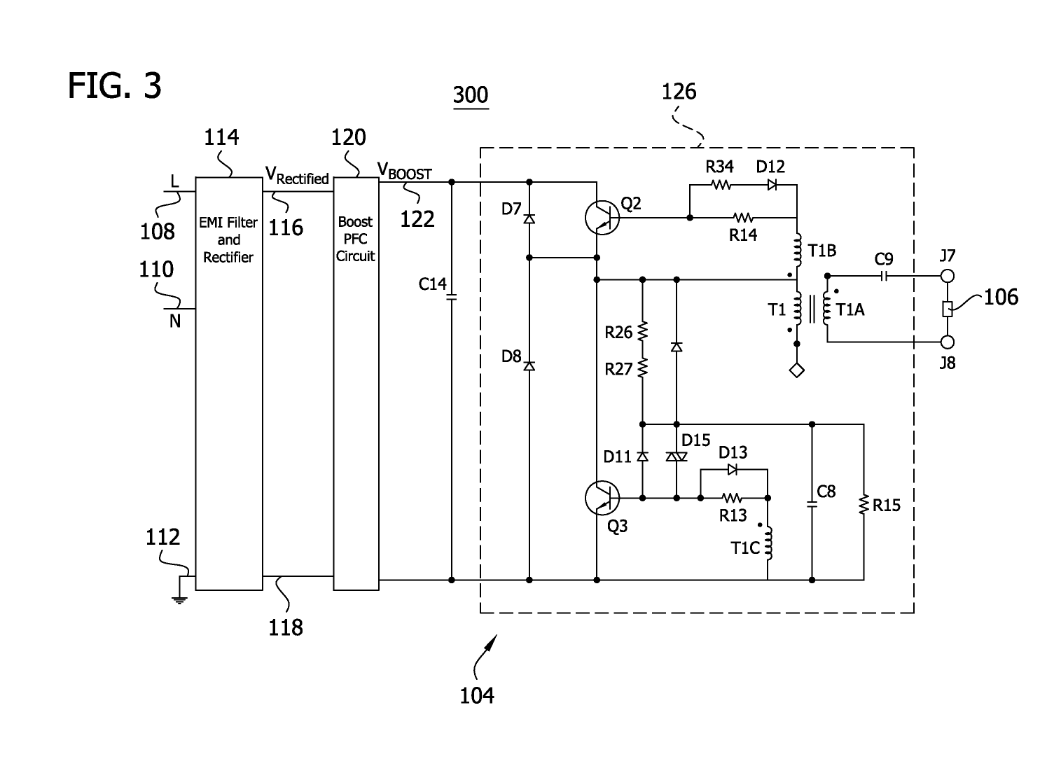

FIG. 3 illustrates a ballast/lamp system 300, which includes many components that are the same (or similar to) the components of the ballast/lamp system 100 shown in FIG. 1. The first drive circuit in the ballast/lamp system 300 includes a resistor R34 connected between the base terminal of the first transistor Q2 and the anode of the diode D12. As such, the resistor R34 and the diode D12 are connected together in series, and the series-connected resistor R34 and diode D12 are connected in parallel with the resistor R12. The added resistance provided by the resistor R34 at the base terminal of the first transistor Q2 slows down the discharge at the base of the first transistor Q2, which increases the amount of time that the first transistor Q2 operates in the conductive state. As such, the duration of the first pulse P₁ is a function of the resistance (e.g., the resistor R34) of the first drive circuit, such that the addition of the resistor R34 to the first drive circuit increases the duration of the first pulse P₁. Accordingly, the first integral value is a function of the first gain h_{FE1} of the first transistor Q2, and of the resistance value of the resistor R34 of the first drive circuit. Thus, the first gain h_{FE1} of the first transistor Q2, the resistance value of the resistor R34 of the first drive circuit, and the second gain h_{FE2} of the second transistor Q3, are each selected and/or designed, relative to one another, so that the first integral value and the second integral value are different. According to the ballast/lamp system 300, the lamp striations are minimized when the following condition is satisfied:

$$\vert \frac{{h}_{FE 2} - 10}{12} - \frac{{h}_{FE 1} - 10}{12} - R 34 \vert \geq 1 \qquad ( equation 2 )$$

In one example, the first and second transistors, Q2 and Q3, are selected from a plurality of transistors having a range of gains. The plurality of transistors having the range of gains can be characterized as transistors having a high gain of around 46, transistors having a medium gain of around 34, and transistors having a low gain of around 22. The resistor R34 can be selected to have a resistance of approximately 1 Ohm or approximately 2 Ohms. In accordance with this example, the first transistor Q2, the second transistor Q3, and the resistor R34 are selected so that the first gain h_{FE1}, the second gain h_{FE2}, and the resistance R34 have particular values governed by equation 2.

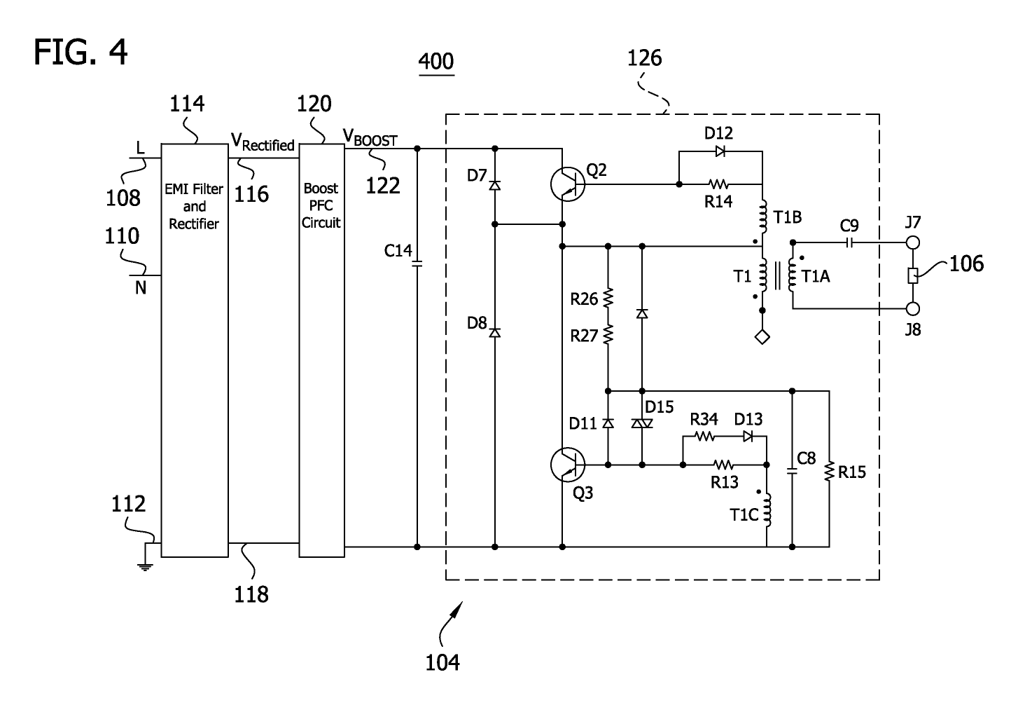

FIG. 4 illustrates a ballast/lamp system 400, which includes many components that are the same (or similar to) the components of the ballast/lamp system 100 shown in FIG. 1 and/or the ballast/lamp system 300 shown in FIG. 3. The second drive circuit in the ballast/lamp system 400 includes a resistor R34 connected between the base terminal of the second transistor Q3 and the anode of the diode D13. As such, the resistor R34 and the diode D13 are connected together in series, and the series-connected resistor R34 and diode D13 are connected in parallel with the resistor R13. The added resistance provided by the resistor R34 at the base terminal of the second transistor Q3 slows down the discharge at the base of the second transistor Q3, which increases the amount of time that the second transistor Q3 operates in the conductive state. As such, the duration of the second pulse P₂ is a function of the resistance (e.g., the resistor R34) of the second drive circuit, such that the addition of the resistor R34 to the second drive circuit increases the duration of the second pulse P₂. Accordingly, the second integral value is a function of the second gain h_{FE2} of the second transistor Q3 and of the resistance value of the resistor R34 of the second drive circuit. Thus, the first gain h_{FE1} of the first transistor Q2, the second gain h_{FE2} of the second transistor Q3, and the resistance value of the resistor R34 of the second drive circuit, are each selected and/or designed, relative to one another, so that the first integral value and the second integral value are different. According to the exemplary ballast/lamp system 400, the lamp striations are minimized when the following condition is satisfied:

$$\vert \frac{{h}_{FE 1} - 10}{12} - \frac{{h}_{FE 2} - 10}{12} - R 34 \vert \geq 1 \qquad ( equation 3 )$$

In one example, the first and second transistors, Q2 and Q3, are selected from a plurality of transistors having a range of gains. The plurality of transistors having the range of gains can be characterized as transistors having a high gain of around 46, transistors having a medium gain of around 34, and transistors having a low gain of around 22. The resistor R34 can be selected to have a resistance of approximately 1 Ohm or approximately 2 Ohms. In accordance with this example, the first transistor Q2, the second transistor Q3, and the resistor R34 are selected so that the first gain h_{FE1}, the second gain h_{FE2}, and the resistance R34 have particular values governed by equation 3.

As described above in connection with ballast/lamp system 100 and equation 1, the minimum value may be dependent on the expected ambient temperature where the ballast will be used. More specifically, the minimum value is increased as the expected ambient temperature is decreased. Thus, in one example, the minimum value of 1 as set forth in equations 2 and 3 may be selected when the expected ambient temperature is around 21 degrees Celsius. However, instead, a minimum value of 2 may be used in equations 2 and 3 when the expected ambient temperature is around 8 degrees Celsius.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A ballast to energize at least one lamp, the ballast comprising:
an inverter circuit to provide an oscillating power signal to energize the at least one lamp, wherein the oscillating power signal has a waveform cycle comprising a first pulse that has a first integral value and a second pulse that has a second integral value, wherein the inverter circuit comprises:
a first transistor having a first gain (h_{FE1}), wherein the first transistor is configured to alternately operate between a conductive state and a non-conductive state; and
a second transistor having a second gain (h_{FE2}), wherein the second transistor is configured to alternately operate between a conductive state and a non-conductive state;
wherein when the first transistor operates in the conductive state, the second transistor operates in the non-conductive state and the first pulse of a waveform cycle of the oscillating power signal is generated and the first integral value of the first pulse is a function of first gain (h_{FE1});
wherein when the second transistor operates in the conductive state, the first transistor operates in the non-conductive state and the second pulse of a waveform cycle of the oscillating power signal is generated and the second integral value of the second pulse is a function of the second gain (h_{FE2}); and
wherein the first integral value of the first pulse of each waveform cycle of the oscillating power signal is different from the second integral value of the second pulse of each waveform cycle such that a differential relationship between first gain (h_{FE1}) and the second gain (h_{FE2}) is greater than or equal to a minimum value in order to minimize striations in the at least one lamp.

2. The ballast of claim 1, wherein the differential relationship comprises:
$$\vert \frac{{h}_{FE 1} - 10}{12} - \frac{{h}_{FE 2} - 10}{12} \vert \geq 1.$$

3. The ballast of claim 1, wherein the minimum value is dependent on an expected ambient temperature for the ballast.

4. The ballast of claim 3, wherein the minimum value is equal to 1 when the expected ambient temperature for the ballast is around 21 degrees Celsius.

5. The ballast of claim 3, wherein the minimum value is equal to 2 when the expected ambient temperature for the ballast is around 8 degrees Celsius.

6. The ballast of claim 1, further comprising:
a rectifier to receive an alternating current (AC) voltage signal and to produce a rectified voltage signal therefrom; and
a power factor correction circuit to receive the rectified voltage signal and to provide a corrected voltage signal, wherein the inverter circuit is connected to the power factor correction circuit and the inverter circuit is configured to generate the oscillating power signal as a function of the corrected voltage signal.

7. The ballast of claim 1, wherein the ballast is configured to energize a plurality of lamps.

8. A ballast to energize at least one lamp, the ballast comprising:
an inverter circuit to provide an oscillating power signal to energize the at least one lamp, wherein the oscillating power signal has a waveform cycle comprising a first pulse that has a first integral value and a second pulse that has a second integral value, and wherein the inverter circuit comprises:
a first transistor having a first gain (h_{FE1}) and configured to alternately operate between a conductive state and a non-conductive state, wherein the first transistor has a base terminal, a collector terminal, and an emitter terminal;
a first drive circuit connected to the base terminal of the first transistor to drive the first transistor, the first drive circuit comprising a resistive component having a resistance value (R34);
a second transistor having a second gain (h_{FE2}) and configured to alternately operate between a conductive state and a non-conductive state, wherein the second transistor has a base terminal, a collector terminal, and an emitter terminal;
a second drive circuit connected to the base terminal of the second transistor to drive the second transistor;
wherein when the first transistor operates in the conductive state, the second transistor operates in the non-conductive state and the first pulse of a waveform cycle of the oscillating power signal is generated and the first integral value of the first pulse is a function of first gain (h_{FE1});
wherein when the second transistor operates in the conductive state, the first transistor operates in the non-conductive state and the second pulse of a waveform cycle of the oscillating power signal is generated and the second integral value of the second pulse is a function of the second gain (h_{FE2}); and
wherein the first integral value of the first pulse of each waveform cycle of the power signal is different from the second integral value of the second pulse of each waveform cycle such that
$$\vert \frac{{h}_{FE 2} - 10}{12} - \frac{{h}_{FE 1} - 10}{12} - R 34 \vert$$
is greater than or equal to a minimum value in order to minimize striations in the at least one lamp.

9. The ballast of claim 8, wherein the minimum value is equal to 1.

10. The ballast of claim 8, wherein the resistive component is a resistor connected to the base terminal of the first transistor.

11. The ballast of claim 8, wherein the first drive circuit further comprises a diode and a resistor, wherein the diode and the resistive component are connected together in a series combination, and the series combination of the diode and the resistive component are connected in parallel with the resistor.

12. The ballast of claim 8, wherein the second drive circuit comprises a diode and a resistor connected together in parallel.

13. The ballast of claim 8, further comprising:
a rectifier to receive an alternating current (AC) voltage signal and to produce a rectified voltage signal therefrom; and
a power factor correction circuit to receive the rectified voltage signal and to provide a corrected voltage signal, wherein the inverter circuit is connected to the power factor correction circuit and the inverter circuit is configured to generate the oscillating power signal as a function of the corrected voltage signal.

14. The ballast of claim 8, wherein the minimum value is dependent on an expected ambient temperature for the ballast.

15. A ballast to energize at least one lamp, the ballast comprising:
an inverter circuit to provide an oscillating power signal to energize the at least one lamp, wherein the oscillating power signal has a waveform cycle comprising a first pulse that has a first integral value and a second pulse that has a second integral value, wherein the inverter circuit comprises:
a first transistor having a first gain (h_{FE1}) and configured to alternately operate between a conductive state and a non-conductive state, wherein the first transistor has a base terminal, a collector terminal, and an emitter terminal;
a first drive circuit connected to the base terminal of the first transistor to drive the first transistor;
a second transistor having a second gain (h_{FE2}) and configured to alternately operate between a conductive state and a non-conductive state, wherein the second transistor has a base terminal, a collector terminal, and an emitter terminal;
a second drive circuit connected to the base terminal of the second transistor to drive the second transistor, the second drive circuit comprising a resistive component having a resistance value (R34);
wherein when the first transistor operates in the conductive state, the second transistor operates in the non-conductive state and the first pulse of a waveform cycle of the oscillating power signal is generated and the first integral value of the first pulse is a function of first gain (h_{FE1});
wherein when the second transistor operates in the conductive state, the first transistor operates in the non-conductive state and the second pulse of a waveform cycle of the oscillating power signal is generated and the second integral value of the second pulse is a function of the second gain (h_{FE2}); and
wherein the first integral value of the first pulse of each waveform cycle of the oscillating power signal is different from the second integral value of the second pulse of each waveform cycle such that
$$\vert \frac{{h}_{FE 1} - 10}{12} - \frac{{h}_{FE 2} - 10}{12} - R 34 \vert$$
is greater than or equal to a minimum value in order to minimize striations in the at least one lamp.

16. The ballast of claim 15, wherein the minimum value is equal to 1.

17. The ballast of claim 15, wherein the second drive circuit further comprises a diode and a resistor, wherein the diode and the resistive component are connected together in a series combination, and the series combination of the diode and the resistive component are connected in parallel with the resistor.

18. The ballast of claim 15, wherein the first drive circuit comprises a diode and a resistor connected together in parallel.

19. The ballast of claim 15, further comprising:
a rectifier to receive an alternating current (AC) voltage signal and to produce a rectified voltage signal therefrom; and
a power factor correction circuit to receive the rectified voltage signal and to provide a corrected voltage signal, wherein the inverter circuit is connected to the power factor correction circuit and the inverter circuit is configured to generate the oscillating power signal as a function of the corrected voltage signal.

20. The ballast of claim 15, wherein the minimum value is dependent on an expected ambient temperature for the ballast.
